(19) United States
(12) Patent Application Publication
(10) Pub. No.: US 2026/0056500 A1
(43) Pub. Date: Feb. 26, 2026

(54) IMAGE FORMING APPARATUS, IMAGE FORMING METHOD, AND RECORDING MEDIUM

(71) Applicants: Shogo NAKAMOTO, Kanagawa (JP); Daisuke INOUE, Kanagawa (JP); Takamasa HASE, Kanagawa (JP); Ryohhei SUGIYAMA, Kanagawa (JP); Arinobu YOSHIURA, Kanagawa (JP)

(72) Inventors: Shogo NAKAMOTO, Kanagawa (JP); Daisuke INOUE, Kanagawa (JP); Takamasa HASE, Kanagawa (JP); Ryohhei SUGIYAMA, Kanagawa (JP); Arinobu YOSHIURA, Kanagawa (JP)

(73) Assignee: ETRIA Co., Ltd., Kanagawa (JP)

(21) Appl. No.: 19/307,539

(22) Filed: Aug. 22, 2025

(30) Foreign Application Priority Data
Aug. 26, 2024 (JP) 2024-144131

(51) Int. Cl. G03G 15/00; G03G 15/20; G03G 21/02; G06K 15/00; G06K 15/12

(52) U.S. Cl. CPC G03G 15/55; G03G 15/2053; G03G 15/2064; G03G 21/02; G06K 15/005; G03G 2215/2035; G06K 15/129

(57) ABSTRACT

An image forming apparatus includes a processor; and a memory that includes instructions, which when executed, cause the processor to execute forming, by an image former, an image on a recording medium; fixing, by a fixer including a rotatable fixing member, the image onto the recording medium, by causing the recording medium on which the image is formed by the image former to be disposed against the fixing member; driving, by a driver, the fixing member; and acquiring, by control circuitry, life information related to a life of the fixer based on either a driving current or a torque of the driver and an operation state of the fixer, and outputting the acquired life information.

### CROSS-REFERENCE TO RELATED APPLICATION

The present application is based on and claims priority under 35 U.S.C. § 119 to Japanese Patent Application No. 2024-144131, filed on Aug. 26, 2024, the contents of which are incorporated herein by reference in their entirety.

### BACKGROUND OF THE INVENTION

### 1. Field of the Invention

The present invention relates to an image forming apparatus, an image forming method, and a recording medium.

### 2. Description of the Related Art

There is known an image forming apparatus that includes a fixing unit for fixing an image to a recording medium, and that acquires information on the life of the fixing unit.

For example, Patent Document 1 discloses a technology for estimating the life of the fixing unit from the slope of the torque value when the torque of the driving unit for driving a rotatable fixing member reaches a threshold value. In this technology, the fixing operation is performed by sliding a fluorine-coated sliding member and the fixing member. When the life of the fixing unit approaches end-of-life, the fluorine coat is peeled off, and the torque of the driving unit increases due to friction between the sliding member and the fixing member, and the life of the fixing unit is estimated based on this feature.
Patent Document 1: Japanese Unexamined Patent Application Publication No. 2020-91454

### SUMMARY OF THE INVENTION

According to one aspect of the present invention, there is provided an image forming apparatus including: a processor; and a memory that includes instructions, which when executed, cause the processor to execute: forming, by an image former, an image on a recording medium; fixing, by a fixer including a rotatable fixing member, the image onto the recording medium, by causing the recording medium on which the image is formed by the image former to be disposed against the fixing member; driving, by a driver, the fixing member; and acquiring, by control circuitry, life information related to a life of the fixer based on either a driving current or a torque of the driver and an operation state of the fixer, and outputting the acquired life information.

### BRIEF DESCRIPTION OF THE DRAWINGS

FIG. 1 is a schematic diagram illustrating the overall configuration of the image forming apparatus according to a first embodiment of the present invention;

FIG. 2 is a block diagram illustrating the overall configuration of the image forming apparatus according to the first embodiment of the present invention;

FIG. 3 is a schematic cross-sectional view illustrating a fixing unit of the image forming apparatus according to the first embodiment of the present invention;

FIG. 4 is a schematic perspective view illustrating the periphery of a holding member of the fixing unit of the image forming apparatus according to the first embodiment of the present invention;

FIG. 5 is a block diagram illustrating the functional configuration of a control unit of the image forming apparatus according to the first embodiment of the present invention;

FIG. 6 is a diagram illustrating the relationship between the average P/J, the number of monthly image forming pages, and the temperature in a fixing member according to the first embodiment of the present invention;

FIG. 7 is a diagram illustrating the relationship between the average P/J, the monthly image forming distance, and the temperature in the fixing member according to the first embodiment of the present invention;

FIG. 8 is a diagram explaining the method of acquiring the life information of the fixing unit in the image forming apparatus according to the first embodiment of the present invention;

FIG. 9 is a table illustrating the operation state of the fixing unit in the image forming apparatus according to the first embodiment of the present invention;

FIG. 10 is a flow diagram illustrating the process of acquiring the life information of the fixing unit by the control unit of the image forming apparatus according to the first embodiment of the present invention;

FIG. 11 is a block diagram illustrating the functional configuration of the control unit of the image forming apparatus according to a second embodiment of the present invention;

FIG. 12 is a diagram explaining the method of acquiring the life information of the fixing unit in the image forming apparatus according to the second embodiment of the present invention;

FIG. 13 is a flow diagram illustrating the process of acquiring the life information of the fixing unit by the control unit of the image forming apparatus according to the second embodiment of the present invention;

FIG. 14 is a flow diagram illustrating the process of acquiring the remaining days information by the control unit of the image forming apparatus according to the second embodiment of the present invention;

FIG. 15 is a block diagram illustrating the functional configuration of the control unit of the image forming apparatus according to a third embodiment of the present invention;

FIG. 16 is a diagram explaining the method of acquiring the life information of the fixing unit in the image forming apparatus according to the third embodiment of the present invention; and

FIG. 17 is a flow diagram illustrating the process of acquiring the life approaching information of the fixing unit by the control unit of the image forming apparatus according to the third embodiment of the present invention.

### DESCRIPTION OF THE EMBODIMENTS

A problem to be addressed by an embodiment of the present invention is to provide an image forming apparatus having high accuracy in acquiring the life information of a fixing unit.

An image forming apparatus, an image forming method, and a recording medium according to an embodiment of the present invention will be described in detail with reference to the drawings. However, the following embodiments are for describing an example of the image forming apparatus, image forming method, and recording medium of the present invention, and are not limited to the following.

The dimensions, materials, shapes, relative arrangements, and the like of the components described in the embodiments of the present invention are not intended to limit the scope of the embodiments of the present invention to only specific embodiments, and are merely illustrative examples, unless it is stated that they are limited to specific embodiments. The sizes, positional relationships, and the like of the members illustrated in the respective drawings may be exaggerated in order to clarify the explanation. In the following description, the same names and symbols refer to the same or similar members, and the detailed explanation thereof is omitted as appropriate. As a cross-sectional view, an end view illustrating only a cut surface may be used. Further, the term “arranging” is not limited to the case of direct contact, but also includes the case of arranging indirectly, for example, via another member.

An image forming apparatus according to an embodiment of the present invention will be described below by using an electrophotographic color printer as an example.

### First Embodiment

### <Configuration of Image Forming Apparatus According To First Embodiment>

### Overall Configuration

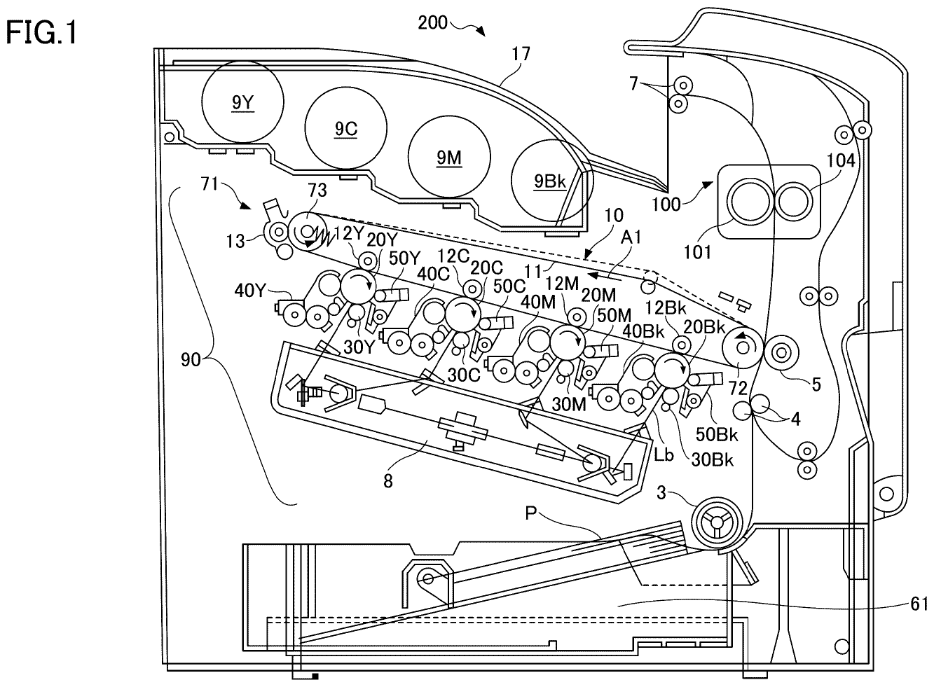

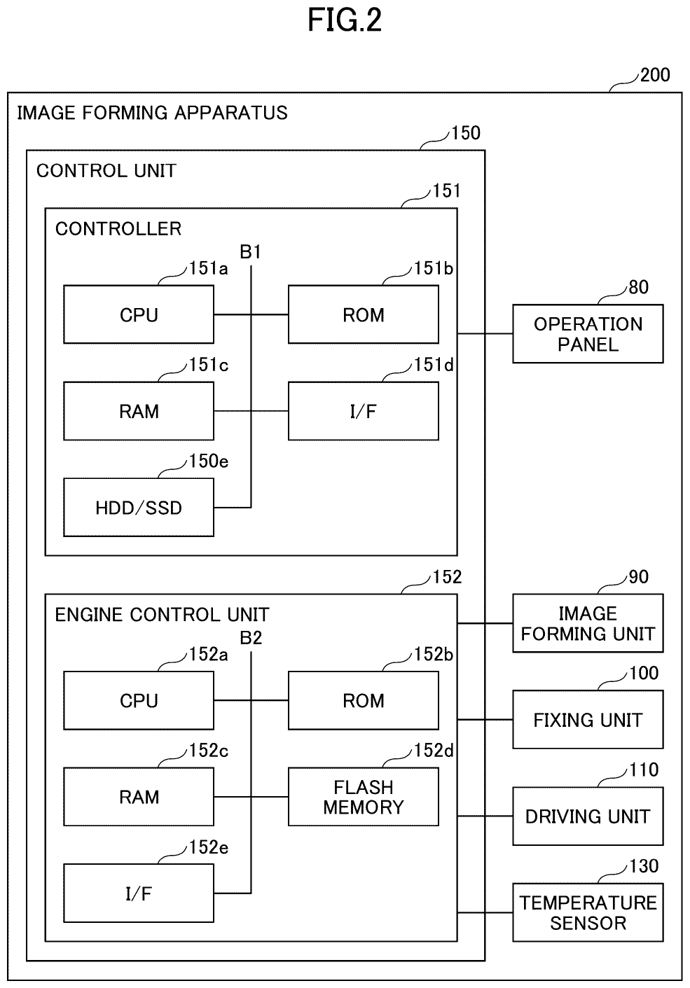

The overall configuration of the image forming apparatus according to the first embodiment of the present invention will be described with reference to FIGS. 1 and 2. FIG. 1 is a schematic diagram illustrating the overall configuration of an image forming apparatus 200 according to the first embodiment of the present invention. FIG. 2 is a block diagram illustrating the overall configuration of the image forming apparatus 200.

The image forming apparatus 200 is a tandem system color printer in which image forming units for forming a plurality of color images are juxtaposed along the traveling direction of a transfer belt 11 serving as an intermediate transfer member. FIG. 1 illustrates the inside of the image forming apparatus 200 in see-through for convenience of explanation.

As illustrated in FIG. 1, the image forming apparatus 200 includes an image forming unit 90 for forming an image on a recording medium P, and a fixing unit 100 which includes a rotatable fixing member 101 and fixes the image on the recording medium P by bringing the recording medium P, on which the image is formed by the image forming unit 90, to be disposed against the fixing member 101. As illustrated in FIG. 2, the image forming apparatus 200 includes a driving unit 110 for driving the fixing member 101, and a control unit 150 which acquires life information related to the life of the fixing unit 100 based on the driving current of the driving unit 110 and the operation state of the fixing unit 100, and outputs the life information. In the example illustrated in FIG. 1, the recording medium P is paper. However, the recording medium P is not limited to paper, and may be a film or the like including a resin material.

In the example illustrated in FIG. 1, the image forming apparatus 200 includes four image stations which perform image forming processing for each color, a transfer belt unit 10, and a secondary-transfer roller 5 which is arranged opposite to the transfer belt 11 and rotates following the transfer belt 11. The image forming apparatus 200 also includes a belt cleaning device 13 which is arranged opposite to the transfer belt 11 and cleans the transfer belt 11, and an optical writing device 8 which is arranged opposite to the above four image stations.

Further, in the example illustrated in FIG. 1, the image forming apparatus 200 includes a feeding device 61 which is a sheet feeding cassette loaded with the recording medium P conveyed to a portion between the transfer belt 11 and the secondary-transfer roller 5. The image forming apparatus 200 also includes a pair of registration rollers 4 which deliver the recording medium P conveyed from the feeding device 61 toward the secondary-transfer portion between the transfer belt 11 and the secondary-transfer roller 5 in accordance with the timing of forming a toner image by the image station. Further, the image forming apparatus 200 has a sensor for detecting that the tip of the recording medium P has reached the pair of registration rollers 4, and an ejection roller 7 for ejecting the recording medium P to which the image is fixed by the fixing unit 100, to the outside of the main body of the image forming apparatus 200. Further, the image forming apparatus 200 has a paper ejection tray 17 for loading the recording medium P ejected to the outside of the main body of the image forming apparatus 200 by the ejection roller 7, and a toner bottle 9Y, a toner bottle 9C, a toner bottle 9M, and a toner bottle 9Bk, each filled with toner of one of the colors of yellow, cyan, magenta, and black.

In the example illustrated in FIG. 2, the image forming apparatus 200 includes a display unit and an operation unit, and includes an operation panel 80 for receiving an operation input from an operator of the image forming apparatus 200, and a temperature sensor 130 for detecting the temperature of the fixing member 101.

In FIG. 1, the four image stations include a photoconductive drum 20Y corresponding to a yellow image, a photoconductive drum 20C corresponding to a cyan image, a photoconductive drum 20M corresponding to a magenta image, and a photoconductive drum 20Bk corresponding to a black image. The photoconductive drum 20Y, the photoconductive drum 20C, the photoconductive drum 20M, and the photoconductive drum 20Bk are juxtaposed along the traveling direction of the transfer belt 11. The photoconductive drum 20Y, the photoconductive drum 20C, the photoconductive drum 20M, and the photoconductive drum 20Bk are image bearers for forming images corresponding to the colors decomposed into yellow, cyan, magenta, and black.

Around each of the photoconductive drum 20Y, the photoconductive drum 20C, the photoconductive drum 20M, and the photoconductive drum 20Bk, a device for performing image forming processing according to the rotation of the corresponding photoconductive drum, is arranged. Each device for performing image forming processing is arranged corresponding to one of the photoconductive drum 20Y, the photoconductive drum 20C, the photoconductive drum 20M, and the photoconductive drum 20Bk. The devices for performing image forming processing for the respective colors have the same function. Taking the photoconductive drum 20Bk for black image formation as a representative example, the device for performing image forming processing has a charging device 30Bk, a developing device 40Bk, a primary-transfer roller 12Bk, and a cleaning device 50Bk arranged along the rotational direction of the photoconductive drum 20Bk.

The optical writing device 8 performs optical writing by using writing light Lb after uniform charging by the charging device 30Bk. The optical writing device 8 includes a semiconductor laser as a light source for writing an electrostatic latent image, a coupling lens, an f6 lens, a toroidal lens, a folding mirror, and a rotating polygon mirror as a deflecting means. The optical writing device 8 forms an electrostatic latent image by radiating each of the photoconductive drum 20Y, the photoconductive drum 20C, the photoconductive drum 20M, and the photoconductive drum 20Bk with writing light corresponding to the color. In the example illustrated in FIG. 1, the writing light Lb is denoted by a reference symbol only for the image station of a black image for convenience, but other image stations are similarly irradiated with writing light corresponding to the color.

The transfer belt unit 10 includes a transfer belt 11, a primary-transfer roller 12Y, a primary-transfer roller 12C, a primary-transfer roller 12M, and a primary-transfer roller 12Bk, and a drive roller 72 and a driven roller 73 around which the transfer belt 11 is wound. The transfer belt 11, the primary-transfer roller 12Y, the primary-transfer roller 12C, the primary-transfer roller 12M, and the primary-transfer roller 12Bk are arranged opposite to the corresponding photoconductive drum 20. The driven roller 73 has a function of energizing the tension with respect to the transfer belt 11 by an energizing means using a spring or the like.

The belt cleaning device 13 has a cleaning brush and a cleaning blade arranged so as to face and be disposed against the transfer belt 11. The belt cleaning device 13 cleans the transfer belt 11 by scraping and removing foreign matter such as residual toner on the transfer belt 11 with the cleaning brush and the cleaning blade. The belt cleaning device 13 also carries out and discards the residual toner removed from the transfer belt 11 by an ejection means.

In the example illustrated in FIG. 1, a transfer device 71 is composed of the transfer belt unit 10, the secondary-transfer roller 5, and the belt cleaning device 13. The image forming unit 90 is composed of the photoconductive drum 20Y, the photoconductive drum 20C, the photoconductive drum 20M, and the photoconductive drum 20Bk, a device for image forming processing by color, and the transfer device 71.

The feeding device 61 is arranged in the lower part of the main body of the image forming apparatus 200 and has a feeding roller 3 that is disposed against the upper surface of the uppermost recording medium P. The feeding roller 3 is driven to rotate counterclockwise in FIG. 1 to feed the uppermost recording medium P toward the pair of registration rollers 4.

In the image forming apparatus 200, a visible image consisting of toner images formed on the photoconductive drum 20Y, the photoconductive drum 20C, the photoconductive drum 20M, and the photoconductive drum 20Bk is primary-transferred to the transfer belt 11. The transfer belt 11 is an endless belt that can travel in the direction of an arrow A1 while facing the photoconductive drum 20Y, the photoconductive drum 20C, the photoconductive drum 20M, and the photoconductive drum 20Bk. By executing a step of primary-transferring the visible image to the transfer belt 11, images of each color are transferred to be superimposed on the transfer belt 11. Then, by executing a step of secondary-transferring, to the sheet-like recording medium P, the toner images that have been primarily-transferred to the transfer belt 11, the toner images in which the images of each color are superimposed, are collectively transferred to the recording medium P.

In the step of primary-transferring, in the process in which the transfer belt 11 travels in the direction of the arrow A1, the toner images formed on the photoconductive drum 20Y, the photoconductive drum 20C, the photoconductive drum 20M, and the photoconductive drum 20Bk are transferred to be superimposed on the same position of the transfer belt 11. In the example illustrated in FIG. 1, the primary-transfer roller 12Y, the primary-transfer roller 12C, the primary-transfer roller 12M, and the primary-transfer roller 12Bk are arranged opposite to the photoconductive drum 20Y, the photoconductive drum 20C, the photoconductive drum 20M, and the photoconductive drum 20Bk across the transfer belt 11. The primary-transfer step is performed by applying a voltage by the primary-transfer roller 12Y, the primary-transfer roller 12C, the primary-transfer roller 12M, and the primary-transfer roller 12Bk, shifting the timing from the upstream side to the downstream side in the direction indicated by the arrow A1.

The image forming apparatus 200 delivers the recording medium P conveyed from the feeding device 61 to the secondary-transfer portion by the pair of registration rollers 4 in accordance with the timing of forming the toner image by the image station. The image forming apparatus 200 secondary-transfers the toner image to the recording medium P at the secondary-transfer portion. The image forming apparatus 200 fixes the secondary-transferred toner image to the recording medium P as an image by the fixing unit 100. The image forming apparatus 200 ejects, by the ejection roller 7, the recording medium P to which the image has been fixed, to the outside of the main body of the image forming apparatus 200. The image forming apparatus 200 loads, on the paper ejection tray 17, the recording medium P ejected to the outside of the main body.

In FIG. 2, the driving unit 110 is, for example, a motor which is arranged inside the image forming apparatus 200 and rotationally drives the fixing member 101.

The image forming unit 90 includes, for example, a function of detecting the driving current of the driving unit 110 according to the torque of the driving unit 110. The driving current increases as the load applied to the driving unit 110 increases and the torque of the driving unit 110 increases according to the load. The image forming apparatus 200 may have a current sensor for detecting the driving current of the driving unit 110 according to the torque of the driving unit 110, separately from the image forming unit 90.

The temperature sensor 130 is, for example, a sensor for detecting the temperature of the widthwise center of the fixing member 101. A temperature sensor having high temperature responsiveness such as a thermopile is used as the temperature sensor 130. The temperature sensor 130 is arranged outside the fixing member 101 and detects the surface temperature and the like of the fixing member 101.

The control unit 150 includes a controller 151 for controlling the entire image forming apparatus 200, and an engine control unit 152 for controlling portions or devices related to image forming processing. The control unit 150 executes various processes by executing an instruction code stored in a memory by an electronic circuit, or by using an electronic circuit designed for special applications, and implements each function of the control unit 150.

The controller 151 includes a central processing unit (CPU) 151a and a read only memory (ROM) 151b, which is a memory for exclusively reading data, for storing control programs. The controller 151 also includes a random access memory (RA) 151c which is a readable/writable memory for temporarily storing data, and an I/F 151d which controls communication between the controller 151 and equipment or devices other than the controller 151. The controller 151 also includes a hard disk drive (HDD)/solid state drive (SSD) 151e which is a non-volatile memory which is a readable/writable memory. These devices are communicably connected via the system bus B1.

The controller 151 outputs, for example, a drive instruction signal of the fixing unit 100 to the engine control unit 152. An operation panel 80 is connected to the controller 151. The controller 151 outputs a display instruction signal to the operation panel 80.

The engine control unit 152 includes a CPU 152a, a ROM 152b, which is a memory for exclusively reading data, for storing control programs, a readable/writable RAM 152c for temporarily storing data, a nonvolatile flash memory 152d, and an I/F 152e for controlling communication between the engine control unit 152 and equipment or devices other than the engine control unit 152. These elements are communicably connected via the system bus B2.

The engine control unit 152 is connected to the image forming unit 90, the fixing unit 100, the driving unit 110, the temperature sensor 130, and the like. The engine control unit 152 controls parts or devices related to image forming processing such as the fixing unit 100 based on a drive instruction signal from the controller 151.

### (Configuration of the Fixing Unit 100)

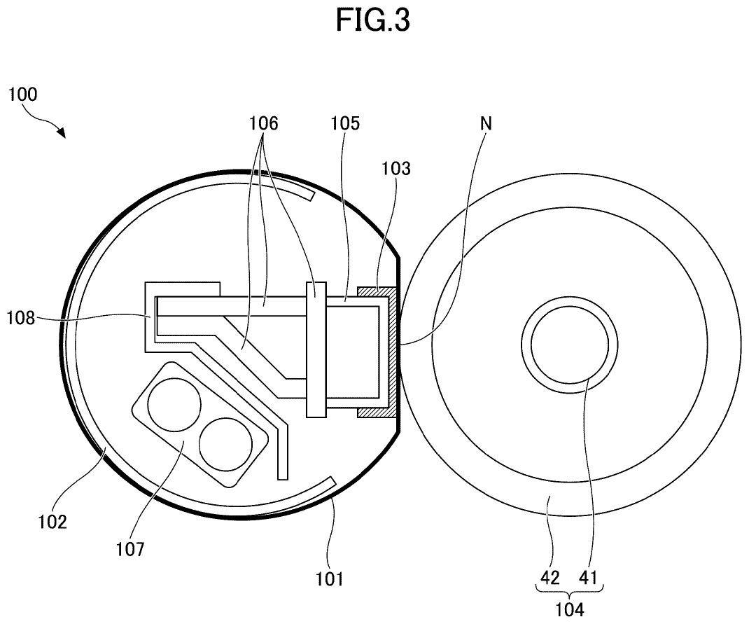

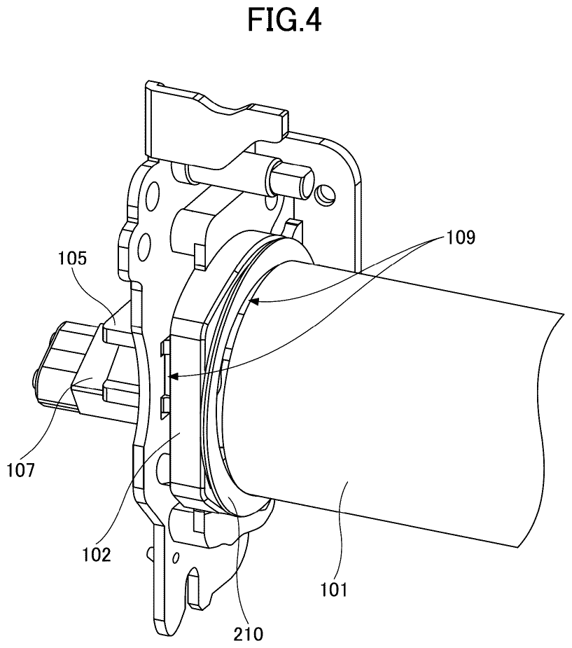

The configuration of the fixing unit 100 will be described with reference to FIGS. 3 and 4. FIG. 3 is a schematic cross-sectional view illustrating the fixing unit 100. FIG. 4 is a schematic perspective view illustrating the periphery of a holding member 102 of the fixing unit 100.

The fixing unit 100 includes a rotatable fixing member 101, the holding member 102 for holding the fixing member 101 at both ends, a sliding member 103 sliding with the inner periphery of the fixing member 101, and a pressurizing member 104 that is disposed against the outer peripheral surface of the fixing member 101. The fixing unit 100 includes a nip forming member 105 arranged inside the fixing member 101 for being disposed against the pressurizing member 104 via the sliding member 103 and the fixing member 101 to form a nip portion N, and a supporting member 106 supporting the nip forming member 105. Further, the fixing unit 100 includes a heat source 107 arranged inside the fixing member 101 for heating the fixing member 101, and a reflecting member 108 reflecting the radiant heat of the heat source 107. The fixing unit 100 fixes the toner image on the recording medium P on which the toner image has been transferred by a contact heating method.

The holding member 102, the sliding member 103, the nip forming member 105, and the heat source 107 arranged inside the fixing member 101 all have a length equal to or longer than the width direction length of the fixing member 101. In the example illustrated in FIG. 3, the fixing member 101 is flexible and endless.

The fixing member 101 is composed of an endless belt or film using a metal belt such as nickel or SUS (Steel Use Stainless) or a resin material such as polyimide. A mold release layer such as a perfluoro alkoxy alkane (PFA) or polytetrafluoroethylene (PTFE) layer is provided on the surface layer of the fixing member 101 in order to prevent toner from adhering to the fixing member 101.

An elastic layer formed of a silicone rubber layer or the like may be provided between the base material of the fixing member 101 and the mold release layer. When the silicone rubber layer is not provided, the heat capacity is reduced and the fixing property is improved. However, when the unfixed image is pressed and fixed, the minute unevenness of the surface of the fixing member 101 is transferred to the image, and the gloss unevenness of an orange peel, that is, an orange peel-like image, may remain on the solid portion of the image. For example, by providing a silicone rubber layer having a thickness of 100 μm or more, the minute unevenness is cancelled out by the deformation of the silicone rubber layer, and the orange peel-like image is improved.

As illustrated in FIGS. 3 and 4, the holding member 102 is arranged at both ends of the fixing member 101 in the width direction. The holding member 102 has a substantially cylindrical shape in which the side on the pressurizing member 104 is cut off. The holding member 102 has an outer diameter substantially the same as the inner diameter of the fixing member 101, and has a length in which a predetermined amount enters the inside from both ends of the fixing member 101. The holding member 102 is inserted into the end of the fixing member 101 and slides to maintain a substantially circular cross-sectional shape of the fixing member 101. In the example illustrated in FIG. 4, the holding member 102 includes a resin member 210 arranged on the outer side in the circumferential direction at the end of the fixing member 101.

In the present embodiment, there is a gap between the fixing member 101 and the holding member 102. In the example illustrated in FIG. 4, the gap 109 corresponds to a gap between the fixing member 101 and the holding member 102. Such a gap includes at least one of an intentionally provided gap or an unintentionally generated gap.

The sliding member 103 is arranged between the nip forming member 105 and the fixing member 101, and slides with the inner periphery of the fixing member 101. Lubricant is applied to the sliding member 103 on the surface facing the fixing member 101 in order to reduce sliding friction resistance with the fixing member 101. That is, lubricant is applied between the surface of the sliding member 103 and the inner periphery of the fixing member 101.

The pressurizing member 104 includes a cored bar 41 and an elastic rubber layer 42. A mold-releasing layer such as a PFA layer or a PTFE layer described above is provided on the surface of the elastic rubber layer 42 to obtain a mold-releasing property. The pressurizing member 104 rotates by receiving a driving force transmitted through a gear from a driving unit such as a motor provided in the image forming apparatus 200. The pressurizing member 104 is pressed against the fixing member 101 side by a spring or the like, and the elastic rubber layer 42 is pressed and deformed to have a predetermined nip width. The pressurizing member 104 may be a hollow roller. The pressurizing member 104 may have a heat source such as a halogen heater inside. The elastic rubber layer 42 may be solid rubber, and if there is no heat source inside the pressurizing member 104, the elastic rubber layer 42 may be sponge rubber. Sponge rubber is more desirable from the viewpoint of improving heat insulation and preventing heat loss of the fixing member 101.

In the example illustrated in FIG. 3, the surface of the nip forming member 105 facing the pressurizing member 104 is flat. However, the surface is not limited thereto, and the surface of the nip forming member 105 facing the pressurizing member 104 may have a concave shape or another shape. By making the surface of the nip forming member 105 facing the pressurizing member 104 have a concave shape, the nip portion N is a concave shape that is recessed towards the fixing member 101 side. As a result, the ejection direction of the recording medium P is toward the pressurizing member 104, thereby improving the separation property, and the occurrence of paper jam is reduced.

The supporting member 106 prevents deflection of the nip forming member 105 under pressure from the pressurizing member 104. By preventing deflection, the width of the nip portion N is uniform in the axial direction of the fixing member 101.

The heat source 107 is, for example, a halogen heater. The fixing member 101 is directly heated by radiation heat of the heat source 107 from the inner peripheral side. The heat source 107 is not limited to a halogen heater as long as the heat source 107 can heat the fixing member 101. For example, the heat source 107 may be electromagnetic induction heating (IH), a resistance heating element, a carbon heater, or the like.

The reflecting member 108 is a member that reflects radiation heat or the like from the heat source 107. Because the reflecting member 108 reflects radiation heat or the like, wasteful energy consumption, caused by heating of the supporting member 106 by radiation heat or the like, is reduced. Instead of having the reflecting member 108, the fixing unit 100 may be heat-insulated or mirror-coated on the surface of the supporting member 106. By being heat-insulated or mirror-coated on the surface of the supporting member 106, the same effect as that of the reflecting member 108 can be obtained.

In the example illustrated in FIGS. 3 and 4, the driving unit 110 rotates the pressurizing member 104 by transmitting a driving force to the pressurizing member 104 through a gear or the like. The rotating driving force of the pressurizing member 104 is transmitted to the fixing member 101 at the nip portion N, whereby the fixing member 101 rotates. In another aspect, the fixing member 101 is rotated by the pressurizing member 104.

The toner image, which is an image on the recording medium P, is fixed to the recording medium P by being heated and pressurized at the nip portion N.

(Functional configuration of the control unit 150)

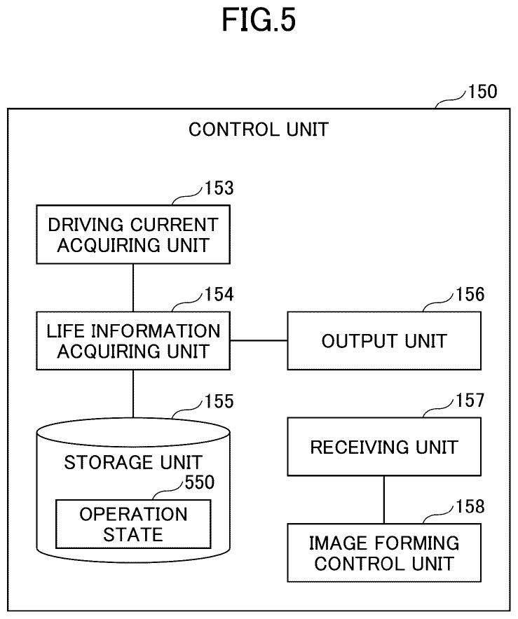

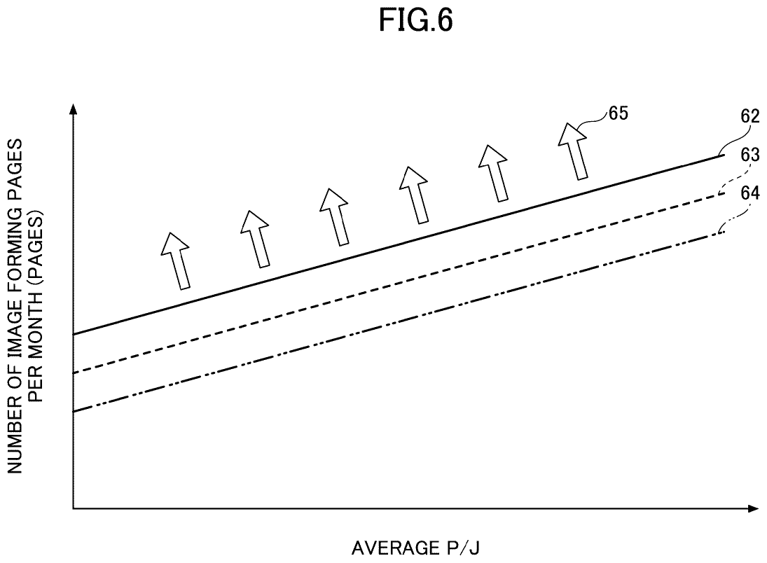

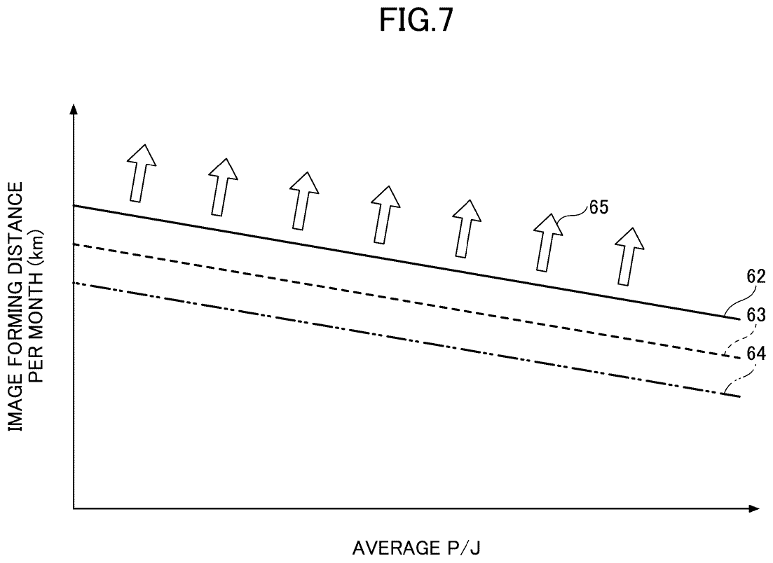

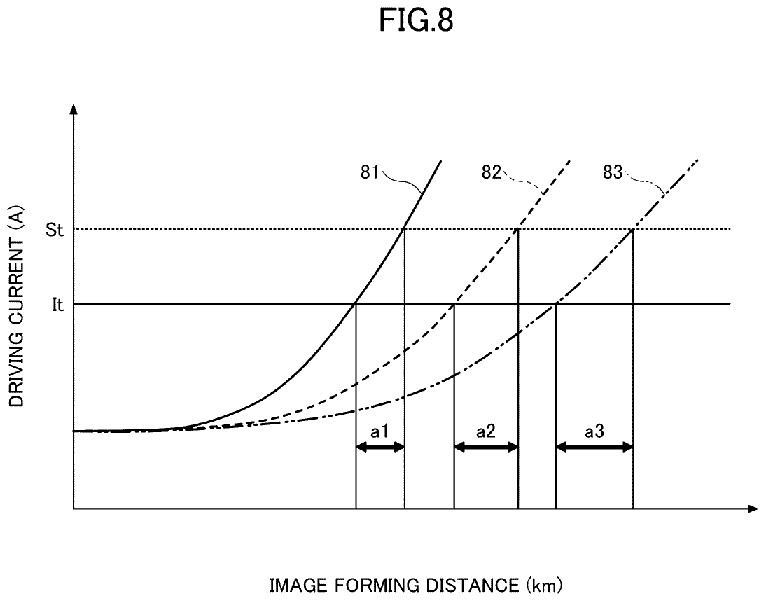

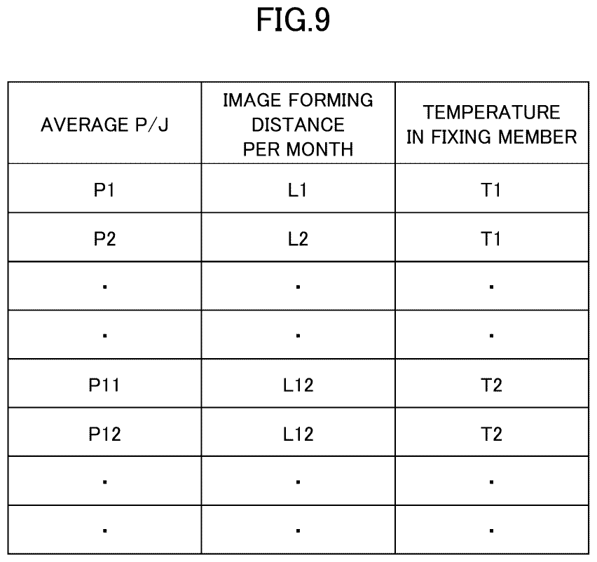

The functional configuration of the control unit 150 will be described with reference to FIGS. 5 to 9. FIG. 5 is a block diagram illustrating the functional configuration of the control unit 150. FIG. 6 is a diagram illustrating the relationship between the average P/J (pages per job), the monthly number of image forming pages, and the temperature in the fixing member 101. FIG. 7 is a diagram illustrating the relationship between the average P/J, the monthly image forming distance, and the temperature in the fixing member 101. FIG. 8 is a diagram explaining the method of acquiring the life information of the fixing unit 100 in the image forming apparatus 200. FIG. 9 is a table illustrating the operation state of the fixing unit 100 in the image forming apparatus 200.

In the example illustrated in FIG. 5, the control unit 150 includes a driving current acquiring unit 153 that acquires information related to the driving current of the driving unit 110, and a life information acquiring unit 154 that acquires life information related to the life of the fixing unit 100 based on the driving current of the driving unit 110 and an operation state 550 of the fixing unit 100. The control unit 150 also includes a storage unit 155 that stores the operation state 550 of the fixing unit 100, and an output unit 156 that outputs the life information acquired by the life information acquiring unit 154. Further, the control unit 150 includes a receiving unit 157 that receives a job requesting image formation from a device or equipment other than the control unit 150, and an image forming control unit 158 that controls the image formation operation of the image forming unit 90. The device or equipment other than the control unit 150 is, for example, a PC (Personal Computer).

The functions of the driving current acquiring unit 153, the output unit 156, and the receiving unit 157 are implemented by the I/F 151d illustrated in FIG. 2 or by the CPU 151a executing an instruction code stored in the ROM 151b. The functions of the life information acquiring unit 154 and the image forming control unit 158 are implemented by the CPU 151a executing an instruction code stored in the ROM 151b. The functions of the storage unit 155 are implemented by the HDD/SSD 151e. However, a part of the above function of the control unit 150 may be implemented by an external device other than the control unit 150, or may be implemented by distributed processing between the control unit 150 and the external device. A part of the above function of the control unit 150 may be implemented by the CPU 152a, the ROM 152b, the I/F 152e, or the like of the engine control unit 152. The external device includes a PC, a server, or the like.

The driving current acquiring unit 153 acquires information related to the driving current of the driving unit 110 from the image forming unit 90 by controlling communication with the image forming unit 90. The output unit 156 outputs the life information acquired by the life information acquiring unit 154 to an external device other than the control unit 150 by controlling communication with the external device. The external device is a PC used by a service person or an administrator of the image forming unit 200, or a portable terminal such as a notebook PC or a smartphone. The output unit 156 may output the life information to a display unit of the operation panel or an external device such as a server.

The receiving unit 157 receives a job requesting image formation from a PC or the like on which a printer driver is installed. The receiving unit 157 transfers the information of the received job to the image forming control unit 158. The image forming control unit 158 outputs a control signal to the image forming unit 90 in response to the job information received from the receiving unit 157, thereby controlling the image forming operation by the image forming unit 90.

Here, for example, in the fixing unit 100, if the lubricant applied between the fixing member 101 and the sliding member 103 decreases with time, the sliding friction resistance between the fixing member 101 and the sliding member 103 increases, and the sliding load increases. When the torque of the driving unit increases according to the sliding load, the fixing member 101, which rotates around with rotary drive of the pressurizing member 104, may slip against the pressurizing member 104. When the slipping phenomenon occurs, the conveyance speed of the recording medium P passing between the pressurizing member 104 and the fixing member 101 slows, and a speed difference with the conveyance speed of the recording medium P passing through another area occurs. Due to this speed difference, the recording medium P loosens between the secondary-transfer portion and the fixing unit 100, and the recording medium P comes into contact with a member existing in the image forming apparatus 200 and is rubbed by this member. Such rubs may cause image abnormalities such as dirt on the recording medium P or partial omission of an image formed on the recording medium P.

As a countermeasure to the above image abnormality, there is known a method of reducing the occurrence of abnormal images by setting the time when the lubricant decreases and the fixing member slips against the pressurizing member as the life of the fixing unit, and replacing the fixing unit which has reached the life of the fixing unit. For example, Patent Document 1 discloses a technology for estimating the life of a fixing unit from the slope of the torque value when the torque of a driving unit for driving a rotatable fixing member reaches a threshold value, and replacing the fixing unit according to the estimation result.

However, in the technology described in Patent Document 1, when the fixing unit is operated in a state where the temperature in the fixing member tends to rise, the fixing unit reaches the end of life earlier than the estimated life, and the accuracy of obtaining information on the life of the fixing unit may be low.

As a result of intensive studies, the inventor clarified the mechanism of the phenomenon that the end of life of the fixing unit becomes earlier as follows. That is, in a state where the average image forming distance per day is long or the average number of image forming pages per day is large, the operating time of the fixing unit becomes longer, and the temperature in the fixing member contained in the fixing unit tends to rise. As the temperature in the fixing member rises, the viscosity of the lubricant applied to the sliding member decreases, and the fluidity increases. As the lubricant tends to flow, the lubricant applied to the sliding member flows out of the sliding member and leaks out of the fixing unit 100 through the gap 109 between the fixing member 101 and the holding member 102 illustrated in FIG. 4. As the lubricant leaks out of the fixing unit 100, the rate at which the lubricant decreases increases. As a result, the fixing unit reaches its end of life earlier than the estimated life.

The number of image forming pages refers to the number of pages on which images are formed on the recording medium. When images are formed on one side of the recording medium, the number of image forming pages on one recording medium corresponds to one page. When images are formed on both sides of the recording medium, the number of image forming pages on one recording medium corresponds to two pages. The image forming distance refers to a value obtained, for example, by multiplying the number of image forming pages by the length of the recording medium in the conveying direction of the recording medium. However, when there is a margin between pages, the image forming distance may be a value obtained by multiplying the number of image forming pages per day by the sum of the length of the recording medium P per page and the margin.

In the present embodiment, the control unit 150 acquires life information related to the life of the fixing unit 100 based on the driving current of the driving unit 110 and the operation state of the fixing unit 100, and outputs the life information. In the example illustrated in FIG. 5, the control unit 150 acquires information related to the driving current of the driving unit 110 detected by the image forming unit 90 from the image forming unit 90 by the driving current acquiring unit 153. The control unit 150 acquires information related to the operation state 550 of the fixing unit 100 by referring to the storage unit 155 which stores information related to the operation state 550 of the fixing unit 100. The control unit 150 acquires life information of the fixing unit 100 by the life information acquiring unit 154 based on the driving current of the driving unit 110 and the operation state 550 of the fixing unit 100.

The operation state 550 of the fixing unit 100 includes, for example, at least one of the average number of image forming pages per job by the image forming apparatus 200, the average number of image forming pages per month by the image forming apparatus 200, the average number of image forming pages per day by the image forming apparatus 200, and the average distance of image forming per day by the image forming apparatus 200.

FIG. 6 illustrates the relationship between the average P/J for each temperature in the fixing member 101 and the number of monthly image forming pages. The average P/J means the number of image forming pages per job. The solid line 62 indicates the case where the temperature in the fixing member 101 is 200° C. The dotted line 63 indicates the case where the temperature in the fixing member 101 is 190° C. The chain double-dashed line 64 indicates the case where the temperature in the fixing member 101 is 180° C.

For example, under the condition that the average P/J is the same, the higher the number of monthly image forming pages, the higher the amount of heat in the fixing member 101, and the temperature in the fixing member 101 tends to rise. Further, under the condition that the number of monthly image forming pages is the same, the lower the average P/J, the more often the fixing unit 100 is started for image formation. As the number of times the fixing unit 100 is started increases, the heating time for starting the fixing unit 100 increases, and the interval for cooling the fixing unit 100 decreases, so the temperature tends to rise. The thick arrow 65 in FIG. 6 indicates the tendency of the operation state of the fixing unit 100 in which the temperature in the fixing member 101 tends to rise. That is, the temperature in the fixing member 101 tends to rise in the direction of the arrow 65. It can be seen from FIG. 6 that the temperature in the fixing member 101 rises as the number of image forming pages increases, and the temperature in the fixing member 101 rises as the average P/J decreases.

FIG. 7 illustrates the relationship between the average P/J for each temperature in the fixing member 101 and the monthly image forming distance. The meanings of the lines 62, 63, 64, and thick arrows 65 in FIG. 7 are the same as those in FIG. 6. As illustrated in FIG. 7, as the number of times the fixing unit 100 is started increases, the amount of rotation of the fixing member 101 at the time of the starting increases, and, therefore, the image forming distance also increases. It can be seen from FIG. 7 that the temperature in the fixing member 101 increases as the image forming distance increases, and the temperature in the fixing member 101 increases as the average P/J increases.

FIG. 8 illustrates how the driving current of the driving unit 110 changes with time for each temperature in the fixing member 101. The solid curve 81 indicates the case where the temperature in the fixing member 101 is 200 degrees. The dotted curve 82 indicates the case where the temperature in the fixing member 101 is 180 degrees. The chain double-dashed curve 83 indicates the case where the temperature in the fixing member 101 is 160 degrees.

A current threshold value It is a predetermined threshold value of the driving current. The slip current value St is a predetermined current value at which the phenomenon of slipping of the fixing member 101 with respect to the pressurizing member 104 occurs.

For the current threshold value It, it is preferable that a current value, by which the slip current value St will not be reached during the period until the visiting day, is predetermined, even when the fixing unit 100 is operated in a state where the temperature in the fixing member 101 is the highest within an assumed range. For example, in the image forming distance when the temperature in the fixing member 101 is high, for example, 200° C., it is preferable that a value, by which a remaining distance “a” calculated by the following equation can be secured, is predetermined.

a={number of days until visiting day}×{average image forming distance per day}

In the above equation, the number of days until visiting day means the number of days taken until a service person actually visits the installation location of the image forming apparatus 200 after requesting the service person of the image forming apparatus 200 to visit the installation location of the image forming apparatus 200. The remaining distance “a” is the image forming distance for securing the number of days until the visiting day of the service person. By securing the remaining distance “a”, the service person can visit the installation location of the image forming apparatus 200 before the slip current value St is reached.

As illustrated in FIG. 8, the higher the temperature in the fixing member 101, the higher the rise rate of the driving current corresponding to the image forming distance. Therefore, the higher the temperature in the fixing member 101, the earlier the end of life of the fixing unit 100 is reached. Although FIG. 8 illustrates the case where the horizontal axis is the image forming distance, a graph with the same tendency is obtained when the horizontal axis is the number of image forming pages.

For example, the storage unit 155 stores association information indicating a relationship between the average P/J, the monthly image forming distance, and the temperature in the fixing member 101 in association with each other, and mathematical expression information indicating the rate of increase of the driving current according to the image forming distance for each temperature in the fixing member 101, as the operation state 550 of the fixing unit 100. The association information indicating a relationship between the average P/J, the monthly image forming distance, and the temperature in the fixing member 101 in association with each other is, for example, a table indicating the relationship between the average P/J, the monthly image forming distance, and the temperature in the fixing member 101 as illustrated in FIG. 9. However, the association information indicating a relationship between the average P/J, the monthly image forming distance, and the temperature in the fixing member 101 in association with each other may be mathematical expression information indicating the relationship between the average P/J, the monthly image forming distance, and the temperature in the fixing member 101. Further, the mathematical expression information indicating the rate of increase of the driving current according to the image forming distance may be a table indicating the association between the image forming distance and the driving current. Note that the storage unit 155 may also store information other than information related to the operation state of the fixing unit 100 such as current information related to the driving current of the driving unit 110 detected by the image forming unit 90.

When the driving current becomes greater than or equal to the predetermined current threshold value It, the life information acquiring unit 154 acquires information related to the temperature in the fixing member 101 by referring to the association information in the operation state 550 based on information related to the average P/J in the image forming apparatus 200 or information related to the monthly image forming distance. Then, based on the temperature in the fixing member 101, the life information acquiring unit 154 acquires mathematical expression information indicating the rate of increase of the driving current according to the image forming distance by referring to the operation state 550 of the storage unit 155. The life information acquiring unit 154 substitutes a predetermined slip current value St into the obtained mathematical expression information, and acquires an image forming distance at which the slip current value St is reached by calculation. The life information acquiring unit 154 uses the acquired image forming distance as the life information of the fixing unit 100. The life information acquiring unit 154 transfers the acquired life information to the output unit 156.

In FIG. 8, the remaining distance a1 indicates the remaining distance “a” when the temperature in the fixing member 101 is 200 degrees. The remaining distance a2 indicates the remaining distance “a” when the temperature in the fixing member 101 is 180 degrees. The remaining distance a3 indicates the remaining distance “a” when the temperature in the fixing member 101 is 160 degrees.

As described above, in the present embodiment, the life information of the fixing unit 100 is acquired based on the driving current of the driving unit 110 and the operation state of the fixing unit 100. Accordingly, because the information related to the operation state of the fixing unit 100 can be taken into account, the image forming apparatus 200 can obtain the life information of the fixing unit 100 with high accuracy even when the fixing unit 100 operates in a state where the temperature in the fixing member 101 tends to rise and reaches the end of life earlier than the estimated life. As a result, in the present embodiment, it is possible to provide the image forming apparatus 200 with high accuracy in obtaining the life information of the fixing unit 100.

The driving current of the driving unit 110 corresponds to the torque of the driving unit 110. Therefore, the image forming apparatus 200 can also obtain the life information of the fixing unit 100 based on the torque of the driving unit 110 and the operation state of the fixing unit 100. When using the torque of the driving unit 110, it is sufficient to replace “driving current” with “torque” in the description of the embodiment.

Further, for example, if the fixing unit 100 reaches the end of life earlier than the estimated life, the fixing unit 100 cannot be replaced, and the fixing member 101 slips with respect to the pressurizing member 104, resulting in an image abnormality, which may cause a downtime in which the image forming apparatus 200 cannot be used. In the present embodiment, by obtaining the life information of the fixing unit 100 with high accuracy, the fixing unit 100 can be replaced before the slippage of the fixing member 101 with respect to the pressurizing member 104 occurs. Thus, in the present embodiment, the occurrence of an image abnormality can be prevented and the occurrence of a downtime in the image forming apparatus 200 can be avoided.

The operation state of the fixing unit 100 includes at least one of the average number of image forming pages per job by the image forming apparatus 200, the average number of image forming pages per month by the image forming apparatus 200, the average number of image forming pages per day by the image forming apparatus 200, and the average image forming distance by the image forming apparatus 200. Accordingly, appropriate information in light of the actual operation state of the image forming apparatus 200 can be used as information related to the operation state of the fixing unit 100. As a result, in the present embodiment, it is possible to provide the image forming apparatus 200 with a high accuracy in obtaining the life information of the fixing unit 100.

The control unit 150 acquires the life information based on the operation state of the fixing unit 100 when the driving current of the driving unit 110 is greater than or equal to the predetermined current threshold value It. When the fixing unit 100 approaches the end of life, the driving current of the driving unit 110 becomes greater than or equal to the predetermined current threshold value It. By acquiring the life information when the driving current of the driving unit 110 is greater than or equal to the predetermined current threshold value It, the processing load for acquiring the life information is reduced compared with the case where the life information is acquired even when the fixing unit 100 is not close to the end of life.

The control unit 150 can replace the initial life information related to the initial life of the fixing unit 100 with the life information acquired based on the operation state of the fixing unit 100. The initial life is, for example, the image forming distance when the driving current of the driving unit 110 reaches the slip current value St under a general room temperature environment. The higher the temperature in the fixing member 101 is when the fixing unit 100 is operated, the shorter the image forming distance in the life information acquired based on the operation state of the fixing 100 is, relative to the image forming distance of the initial life information. That is, the fixing unit 100 reaches the end of life obtained based on the operation state of the fixing unit 100 earlier than the initial life. By replacing the initial life information with the life information, the image forming apparatus 200 can acquire the life information of the fixing unit 100 with high accuracy even when the end of life is reached earlier than the estimated life.

The control unit 150 acquires the life information based on the driving current of the driving unit 110 and the temperature information of the fixing member 101 based on the operation state of the fixing unit 100. Thus, the image forming apparatus 200 can acquire the life information of the fixing unit 100 with high accuracy even when the fixing unit 100 operates in a state where the temperature in the fixing member 101 tends to rise and the end of life is reached earlier than the estimated life.

The image forming apparatus 200 has a storage unit 155 for storing the operation state of the fixing unit 100, and the control unit 150 acquires information related to the operation state of the fixing unit 100 by referring to the storage unit 155. For example, if a device other than the image forming apparatus 200 stores the operation state of the fixing unit 100, and communication between the device and the image forming apparatus 200 becomes impossible, the image forming apparatus 200 cannot acquire the operation state of the fixing unit 100 and cannot update the operation state. Because the storage unit 155 of the image forming apparatus 200 stores the operation state of the fixing unit 100, it is possible to prevent a state where the image forming apparatus 200 cannot acquire the operation state of the fixing unit 100 or the image forming apparatus 200 cannot update the operation state.

The fixing unit 100 includes the fixing member 101, the holding member 102, the sliding member 103, the pressurizing member 104, the nip forming member 105, the supporting member 106, the heat source 107, and the reflecting member 108. The fixing member 101 is flexible and endless. In such a fixing unit 100, a gap is formed between the fixing member 101 and the holding member 102, and when the fixing unit 100 is operated in a state where the temperature in the fixing member 101 tends to rise, the lubricant which has become more fluid may flow out of the fixing unit 100 through the gap. The more the lubricant flows out, the earlier the fixing unit 100 reaches the end of life, and as a result, the accuracy of obtaining the life information becomes low. In the present embodiment, the life information of the fixing unit 100 is obtained based on the driving current of the driving unit 110 and the operation state of the fixing unit 100. Thus, the image forming apparatus 200 can obtain the life information of the fixing unit 100 with high accuracy even when the fixing unit 100 is operated in a state where the temperature in the fixing member 101 tends to rise.

### <Processing by the Control Unit 150>

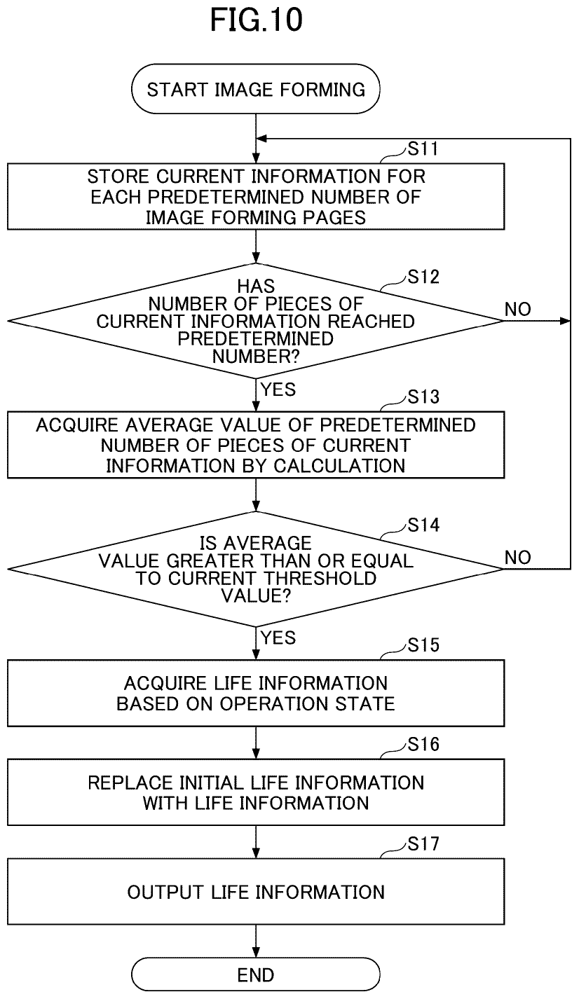

FIG. 10 is a flowchart illustrating the process of obtaining the life information of the fixing unit 100 by the control unit 150. It is assumed that the information on the operation state of the fixing unit 100 is acquired in advance and stored in the storage unit 155.

The control unit 150 starts the process of FIG. 10 on the condition that, for example, the receiving unit 157 receives a job requesting image formation from a device or equipment other than the control unit 150. However, the start condition may be that an operation input to start image formation by the operator of the image forming apparatus 200 has been received via the operation panel 80.

First, in step S11, the control unit 150 stores current information related to the driving current of the driving unit 110 for each predetermined number of image forming pages by the storage unit 155. The predetermined number of image forming pages is, for example, the most recent 100 pages on which image formation has been performed. The storage unit 155 sequentially stores additional current information acquired by the driving current acquiring unit 153.

Subsequently, in step S12, the control unit 150 determines whether or not the number of pieces of current information acquired in step S11 has reached the predetermined number.

If it is determined in step S12 that the number of pieces of current information has not reached the predetermined number (step S12, NO), the control unit 150 returns to step S11 and repeats the processing from step S11 until it is determined in step S12 that the number of pieces of current information has reached the predetermined number. On the other hand, if it is determined in step S12 that the number of pieces of current information has reached the predetermined number (step S12, YES), the control unit 150 calculates the average value of the predetermined number of pieces of current information in step S13. The storage unit 155 may erase the stored predetermined number of pieces of current information after the calculation of the average value by the control unit 150.

Subsequently, in step S14, the control unit 150 determines whether the average value obtained in step S13 is greater than or equal to the predetermined current threshold value It. The current threshold value It is previously stored in the storage unit 155 or the like. The control unit 150 determines whether the average value is greater than or equal to the predetermined current threshold value It by comparing the average value with the current threshold value It read from the storage unit 155.

The predetermined number of pieces of current information items is, for example, 10. If the average value is calculated every 100 pages, it is possible to determine whether the driving current value is greater than or equal to the current threshold value It by averaging the driving current values for the most recent 1000 pages in total. By comparing the average value with the current threshold value It, the influence of the detection error of the driving current can be reduced.

If it is determined in step S14 that the average value is not greater than or equal to the current threshold value (step S14, NO), the control unit 150 returns to step S11 and repeats the processing from step S11 until it is determined in step S14 that the average value is greater than or equal to the current threshold value.

On the other hand, if it is determined in step S14 that the average value is greater than or equal to the current threshold value (step S14, YES), the control unit 150 calculates and acquires the life information of the fixing unit 100 based on the operation state of the fixing unit 100 by the life information acquiring unit 154 in step S15. For example, the life information acquiring unit 154 acquires information about the temperature in the fixing member 101 by referring to the table illustrated in FIG. 9 based on information about the average P/J or information about the monthly image forming distance in the image forming apparatus 200. Then, based on the temperature in the fixing member 101, the life information acquiring unit 154 acquires mathematical expression information indicating the rate of increase of the driving current according to the image forming distance by referring to the operation state 550 in the storage unit 155. The life information acquiring unit 154 substitutes a predetermined slip current value St into the obtained mathematical expression information, and calculates and acquires the image forming distance at which the slip current value St is reached.

Subsequently, in step S16, the control unit 150 replaces the initial life information about the life of the fixing unit 100 with the life information acquired in step S15.

Subsequently, in step S17, the control unit 150 outputs the life information of the fixing unit 100 to a device or equipment other than the control unit 150 by the output unit 156. Note that the processes of steps S16 and S17 may be one process. For example, the control unit 150 may replace the initial life information with the life information by outputting the life information to a device or equipment other than the control unit 150 that stores the initial life information.

As described above, the control unit 150 can acquire and output the life information of the fixing unit 100.

### Second Embodiment

Next, an image forming apparatus according to the second embodiment will be described. Note that the same names and symbols as those of the already described embodiment indicate the same or the similar type of members or configurations, and the detailed description thereof will be omitted accordingly. This point also applies to the following embodiments.

### <Functional Configuration of the Control Unit of the Image Forming Apparatus According to the Second Embodiment>

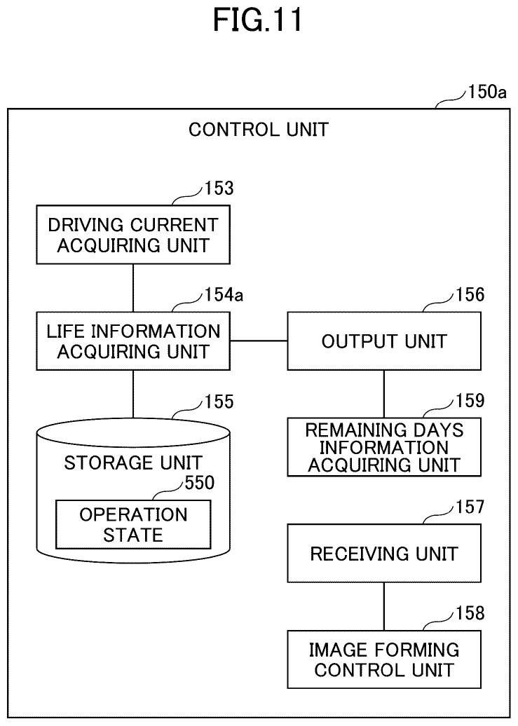

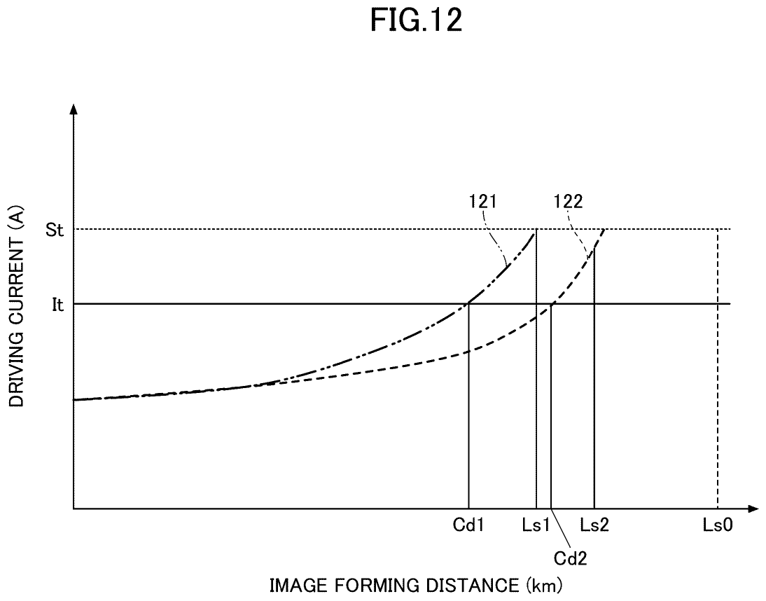

The functional configuration of the control unit of the image forming apparatus according to the second embodiment will be described with reference to FIGS. 11 and 12. FIG. 11 is a block diagram illustrating the functional configuration of a control unit 150a of the image forming apparatus according to the second embodiment. FIG. 12 is a diagram for explaining the method of acquiring the life information of the fixing unit 100 in the image forming apparatus according to the second embodiment.

The image forming apparatus according to the second embodiment differs from the image forming apparatus 200 according to the first embodiment in that the control unit 150a acquires the life information of the fixing unit 100 further based on the visiting day number information (information of the number of days until the visiting day) related to the number of days until the visiting day described above.

As illustrated in FIG. 11, the control unit 150a includes a life information acquiring unit 154a for acquiring life information of the fixing unit 100 based on the driving current of the driving unit 110, the operation state of the fixing unit 100, and the visiting day number information. In the example illustrated in FIG. 11, the control unit 150a includes a remaining days information acquiring unit 159 for acquiring remaining days information related to the remaining days until the fixing unit 100 reaches the end of life based on the driving current of the driving unit 110 and the operation state of the fixing unit 100.

The functions of the life information acquiring unit 154a and the remaining days information acquiring unit 159 are implemented by, for example, the CPU 151a illustrated in FIG. 2 executing an instruction code stored in the ROM 151b.

For example, when the driving current of the driving unit 110 acquired by the driving current acquiring unit 153 becomes greater than or equal to the current threshold value It, the life information acquiring unit 154a acquires information related to the life of the fixing unit 100 based on the operation state of the fixing unit 100 and the number of days until the visiting day of the service person.

In FIG. 12, a chain double-dashed curve 121 indicates the relationship between the image forming distance and the driving current of the driving unit 110 when the image forming distance per day is long when the fixing unit 100 is operated in a state where the temperature in the fixing member 101 tends to rise. A dashed curve 122 indicates the relationship between the image forming distance and the driving current of the driving unit 110 when the image forming distance per day is short when the fixing unit 100 is operated in a state where the temperature in the fixing member 101 tends to rise. The initial life information Ls0 represents the image forming distance corresponding to the initial life of the fixing unit 100.

The life information Ls1 represents the image forming distance corresponding to the life obtained based on the operation state of the fixing unit 100 and the number of days until the visiting day of the service person when the image forming distance per day is long when the fixing unit 100 is operated in a state where the temperature in the fixing member 101 tends to rise. The current distance Cd1 represents the current image forming distance of the fixing unit 100 when the life of the fixing unit 100 is the life information Ls1. The life information Ls1 is calculated by the following equation:

Ls1={number of days until visiting day}×{average image forming distance per day}+Cd1

The life information Ls2 represents the image forming distance corresponding to the life obtained based on the operation state of the fixing unit 100 and the number of days until the visiting day of the service person when the image forming distance per day is short when the fixing unit 100 is operated in a state where the temperature in the fixing member 101 tends to rise. The current distance Cd2 represents the current image forming distance of the fixing unit 100 when the life of the fixing unit 100 is the life information Ls2. The life information Ls2 is calculated by the following equation:

Ls2={number of days until visiting day}×{average image forming distance per day}+Cd2

In the present embodiment, the control unit 150a acquires information on the life of the fixing unit 100 based on the operation state of the fixing unit 100 and the number of days until the visiting day of the service person, so that the service person can surely visit the setting location of the image forming apparatus before the driving current of the driving unit 110 reaches the slip current value St. Thus, because the fixing unit 100 can be replaced before the fixing unit 100 reaches the end of its life, the occurrence of downtime of the image forming apparatus can be prevented.

In a state where the temperature in the fixing member 101 does not easily rise, the life of the fixing unit 100 is set before the driving current of the driving unit 110 reaches the slip current value St. Thus, because the number of days until the visiting day of the service person can be secured, the occurrence of downtime of the image forming apparatus can be prevented.

The remaining days information acquiring unit 159 can obtain, for example, the remaining days Rd by calculation according to the following equation.

Rd=(Ls−Cd)/Da

In the above equation, the image forming distance DL is, for example, a value obtained by multiplying the number of image forming pages per day by the image forming apparatus by the length of the recording medium P per page. However, when there is a margin between pages, the image forming distance DL may be a value obtained by multiplying the number of image forming pages per day by the sum of the length of the recording medium P per page and the sum of the margins. The image forming distance DL corresponds to the life information Ls1 or the life information Ls2, etc. The current distance Cd is the image forming distance up to the present time by the image forming apparatus. The average image forming distance Da per day is, for example, a value obtained by multiplying the average number of image forming pages per day by the image forming apparatus by the length of the recording medium P per page. However, when there is a margin between pages, the average image forming distance Da per day may be a value obtained by multiplying the average number of image forming pages per day by the sum of the length of the recording medium P per page and the margin.

Even after the life information is obtained by the life information acquiring unit 154a, the remaining days information acquiring unit 159 continues to obtain the remaining days by calculation according to the operation state of the fixing unit 100. The output unit 156 outputs the remaining days information obtained by the remaining days information acquiring unit 159. For example, the output unit 156 can sequentially notify the remaining days information to a PC or a smartphone managed by a service person.

For example, when the fixing unit 100 is operated in a state where the temperature in the fixing member 101 tends to rise, the rate at which the number of remaining days decreases will increase. When the control unit 150a sequentially notifies the service person of the remaining days information, even when the number of remaining days decreases rapidly, the service person can be made to visit the installation location of the image forming apparatus before downtime of the image forming apparatus occurs. Thus, the fixing unit 100 can be replaced before the fixing unit 100 reaches the end of its life, and, therefore, the occurrence of downtime of the image forming apparatus can be prevented.

On the other hand, when the fixing unit 100 is operated in a state where the temperature in the fuser sleeve does not easily rise, the rate at which the number of remaining days decreases becomes slower. When the control unit 150a sequentially notifies the service person of the remaining days information, even when the number of remaining days decreases slowly, the service person can be made to visit the installation location of the image forming apparatus at an appropriate time with respect to downtime of the image forming apparatus.

It is preferable to notify the service person of the remaining days information at the timing when the control unit 150a acquires the life information. However, the timing of notifying the service person of the remaining days information does not necessarily need to be at the timing when the control unit 150a acquires the life information.

<Process by the Control Unit 150a>

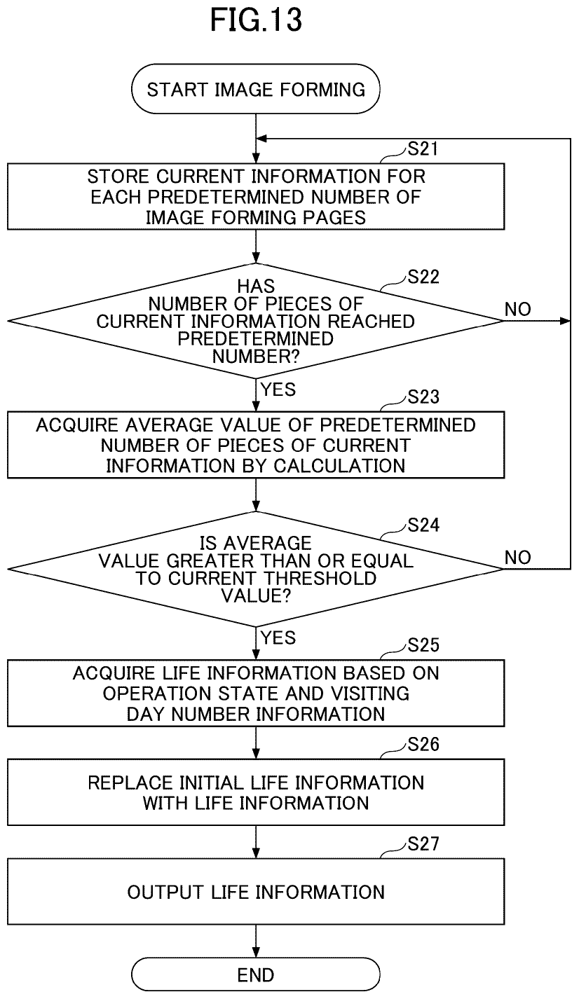

FIG. 13 is a flowchart illustrating the process of acquiring the life information of the fixing unit 100 by the control unit 150a. Descriptions of the same parts as those in FIG. 10 will be omitted as appropriate, and differences from FIG. 10 will be mainly described.

In step S25, the control unit 150a acquires the life information based on the operation state of the fixing unit 100 and the visiting day number information by the life information acquiring unit 154a. The control unit 150a replaces the initial life information with the acquired life information, and then outputs the life information to a device or equipment other than the control unit 150a.

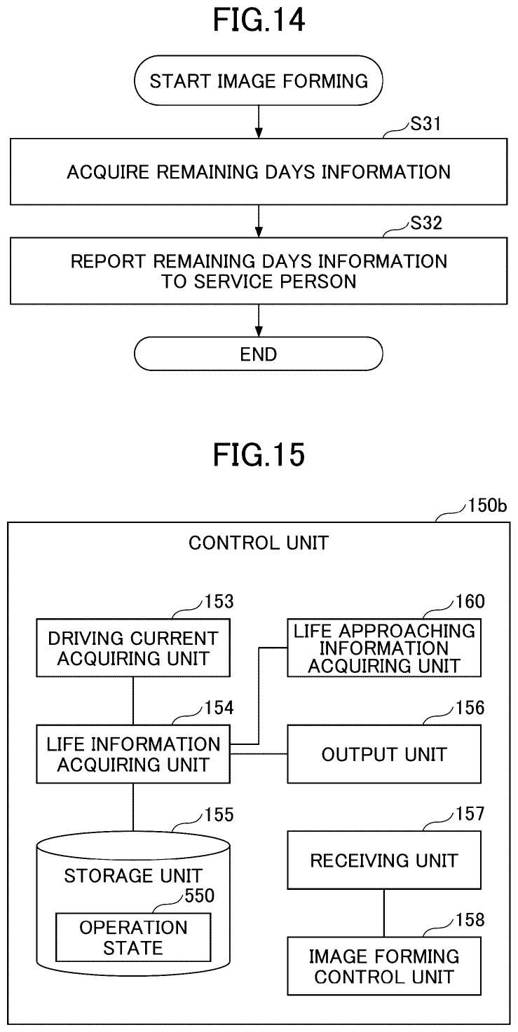

FIG. 14 is a flowchart illustrating the remaining days information acquisition process by the control unit 150a. The control unit 150a starts the process of FIG. 14 on the condition that the receiving unit 157 receives a job requesting image formation from a device or equipment other than the control unit 150a. However, the start condition may be that an operation input to start image formation from the operator of the image forming apparatus is received via the operation panel 80.

First, in step S31, the control unit 150a acquires remaining days information based on the driving current of the driving unit 110 and the operation state of the fixing unit 100 by the remaining days information acquiring unit 159. The remaining days information acquiring unit 159 transfers the acquired remaining days information to the output unit 156.

Subsequently, in step S32, the control unit 150a outputs the remaining days information received from the remaining days information acquiring unit 159 to a device or apparatus other than the control unit 150a by the output unit 156.

As described above, the control unit 150a can acquire and output remaining days information.

### Third Embodiment

Next, an image forming apparatus according to the third embodiment will be described.

### <Functional Configuration of the Control Unit of the Image Forming Apparatus According to the Third Embodiment>

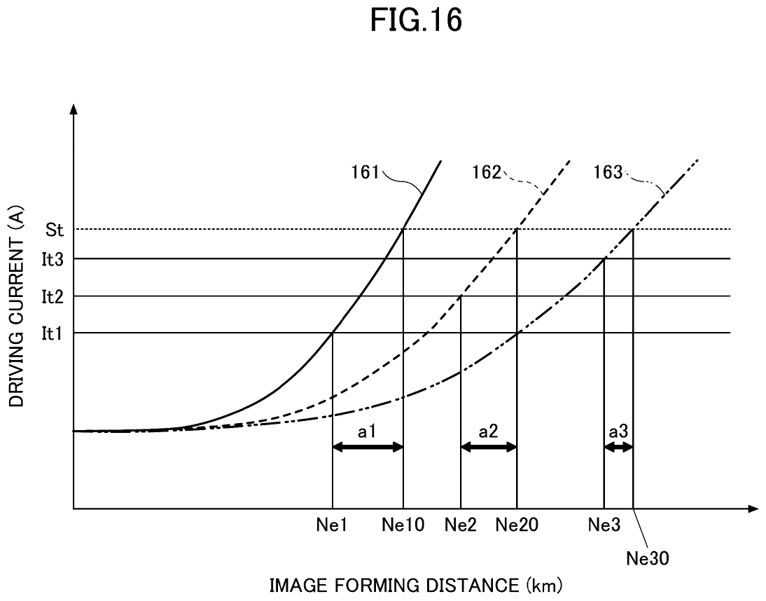

The functional configuration of the control unit of the image forming apparatus according to the third embodiment will be described with reference to FIGS. 15 and 16. FIG. 15 is a block diagram illustrating the functional configuration of the control unit 150b of the image forming apparatus according to the third embodiment. FIG. 16 is a diagram for explaining the method of acquiring the life information of the fixing unit in the image forming apparatus according to the third embodiment.

The image forming apparatus according to the present embodiment differs from the image forming apparatus 200 according to the first embodiment in that the control unit 150b acquires life approaching information related to approaching the end of life of the fixing unit 100 based on the visiting day number information and the life information of the fixing unit 100, and outputs the life approaching information.

As illustrated in FIG. 15, the control unit 150b has a life approaching information acquiring unit 160 for acquiring the life approaching information related to approaching the end of life of the fixing unit 100 based on the visiting day number information and the life information of the fixing unit 100. The function of the life approaching information acquiring unit 160 is implemented by the CPU 151a illustrated in FIG. 2 executing an instruction code stored in the ROM 151b.

FIG. 16 illustrates how the driving current of the driving unit 110 changes with time for each temperature in the fixing member 101. The solid curve 161 illustrates the case where the temperature in the fixing member 101 is 200 degrees. The dotted curve 162 illustrates the case where the temperature in the fixing member 101 is 180 degrees. The chain double-dashed curve 163 illustrates the case where the temperature in the fixing member 101 is 160 degrees.

The current threshold value It1 is the current threshold value It corresponding to the image forming distance that ensures the visiting day number when the fixing unit 100 is operated in the case where the temperature in the fixing member 101 is 200° C. The current threshold value It2 is the current threshold value It corresponding to the image forming distance that ensures the visiting day number when the fixing unit 100 is operated in the case where the temperature in the fixing member 101 is 180° C. The current threshold value It3 is the current threshold value It corresponding to the image forming distance that ensures the visiting day number when the fixing unit 100 is operated in the case where the temperature in the fixing member 101 is 160° C.

The life approach information is, for example, an image forming distance corresponding to the current threshold value It, which is a current value indicating that the slip current value St is approaching. The life approach information Ne1 is an image forming distance corresponding to the current threshold value It1. The initial life approach information Ne10 is an image forming distance at which the slip current value St is reached when the fixing unit 100 is operated in a case where the temperature in the fixing member 101 becomes 200° C. The life approach information Ne2 is an image forming distance corresponding to the current threshold value It2. The initial life approach information Ne20 is an image forming distance at which the slip current value St is reached when the fixing unit 100 is operated in a case where the temperature in the fixing member 101 becomes 180° C. The life approach information Ne3 is an image forming distance corresponding to the current threshold value It3. The initial life approach information Ne30 is an image forming distance at which the slip current value St is reached when the fixing unit 100 is operated in a case where the temperature in the fixing member 101 becomes 160° C.

The remaining distance a1 indicates the remaining distance “a” when the temperature in the fixing member 101 is 200° C. The remaining distance a2 indicates remaining distance “a” when the temperature in the fixing member 101 is 180 degrees. The remaining distance a3 indicates remaining distance “a” when the temperature in the fixing member 101 is 160 degrees.

The control unit 150b acquires the image forming distance corresponding to the current threshold value It as the life approaching information, and outputs the acquired image forming distance to a PC or a smartphone managed by the service person, thereby alerting the service person that the fixing unit 100 is approaching its end of life. Further, the control unit 150b determines the life approaching information based on the visiting day number information and the life information of the fixing unit 100, thereby ensuring the number of days until the visiting day of the service person such that the driving current of the driving unit 110 does not reach the slip current value St. The control unit 150b can also increase the current threshold value It when the fixing unit 100 operates in a case where the temperature in the fixing member 101 does not rise. That is, the control unit 150b can also change the current threshold value It based on the operation state of the fixing unit 100 and the number of days until the visiting day of the service person.

<Process by the Control Unit 150b>

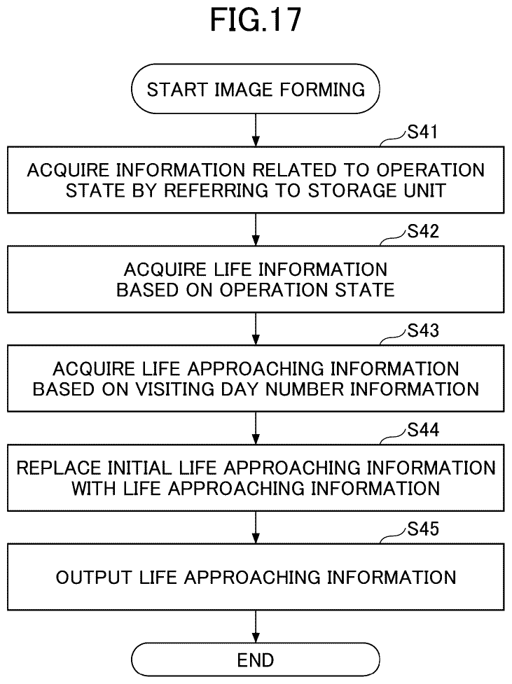

FIG. 17 is a flowchart illustrating the process of acquiring the life approaching information of the fixing unit 100 by the control unit 150b. It is assumed that the information on the operation state of the fixing unit 100 is acquired in advance and stored in the storage unit 155.

The control unit 150b starts the process of FIG. 17 on the condition that, for example, the receiving unit 157 receives a job requesting image formation from a device or equipment other than the control unit 150b. However, the start condition may be that an operation input to start image formation by the operator of the image forming apparatus is received via the operation panel 80.

First, in step S41, the control unit 150b acquires information on the operation state of the fixing unit 100 by referring to the storage unit 155 by the life information acquiring unit 154.

Next, in step S42, the control unit 150b acquires life information on the fixing unit 100 based on the operation state of the fixing unit 100 by the life information acquiring unit 154. For example, the life information acquiring unit 154 acquires information on the image forming distance at which the slip current value St is reached, as life information.

Then, in step S43, the control unit 150b acquires the life approaching information based on the visiting day number information by the life approaching information acquiring unit 160.

Then, in step S44, the control unit 150b replaces the initial life approaching information with the acquired life approaching information by the life approaching information acquiring unit 160.

Then, in step S45, the control unit 150b outputs the life approaching information of the fixing unit 100 to a device or equipment other than the control unit 150b by the output unit 156. Note that the processes of steps S44 and S45 may be one process. For example, the control unit 150b may replace the initial life approaching information with the life approaching information by outputting the life information to a device or equipment other than the control unit 150b that stores the initial life approaching information.

As described above, the control unit 150b can acquire and output the life approaching information of the fixing unit 100.

Although the preferred embodiments have been described in detail above, embodiments are not limited to the above-described embodiments of the present invention, and various modifications and substitutions may be made to the above-described embodiments of the present invention without departing from the scope of claims.

The image forming apparatus according to the embodiments of the present invention is not limited to a tandem system, but may be a system for directly transferring a toner image formed on a photoconductive drum onto a recording medium. The image forming apparatus according to the embodiments of the present invention is not limited to a printer, but may be an MFP (Multifunction Peripheral), a copier, a facsimile machine, or the like.

The numerals such as ordinals and quantities used in the description of the embodiments of the present invention are all exemplified for the purpose of specifically explaining the technology of the present invention, and the present invention is not limited to the exemplified numerals. The connection relationship between the components is exemplified for the purpose of specifically explaining the technology of the present invention, and the connection relationship for implementing the function of the present invention is not limited thereto.

The embodiments of the present invention are, for example, as follows.

<1> An image forming apparatus including: an image former configured to form an image on a recording medium;
a fixer including a fixing member that is rotatable and configured to fix the image onto the recording medium, by causing the recording medium on which the image is formed by the image former to be disposed against the fixing member;
a driver configured to drive the fixing member; and
control circuitry configured to acquire life information related to a life of the fixer based on either a driving current or a torque of the driver and an operation state of the fixer, and to output the acquired life information.

<2> The image forming apparatus according to <1>, wherein the operation state of the fixer includes at least one of an average number of image forming pages per job by the image forming apparatus, an average number of image forming pages per month by the image forming apparatus, an average number of image forming pages per day by the image forming apparatus, or an average image forming distance per day.

<3> The image forming apparatus according to <1> or <2>, wherein the control circuitry acquires the life information based on the operation state of the fixer when the driving current of the driver becomes a predetermined current threshold value or more.

<4> The image forming apparatus according to <3>, wherein the control circuitry changes the predetermined current threshold value based on the operation state and a number of days until a visiting day of a service person.

<5> The image forming apparatus according to any one of <1> to <4>, wherein the control circuitry replaces initial life information related to an initial life of the fixer with the life information acquired based on the operation state of the fixer.

<6> The image forming apparatus according to any one of <1> to <5>, wherein the control circuitry acquires the life information based on the driving current of the driver and temperature information related to a temperature of the fixing member based on the operation state of the fixer.

<7> The image forming apparatus according to any one of <1> to <6>, wherein the control circuitry acquires the life information further based on visiting day number information related to a number of days taken until a visiting day when a service person of the image forming apparatus actually visits the image forming apparatus, after requesting the service person to visit the image forming apparatus.

<8> The image forming apparatus according to any one of <1> to <7>, wherein the control circuitry acquires remaining days information related to a number of remaining days until the fixer reaches an end of the life based on the driving current of the driver and the operation state of the fixer, and outputs the acquired remaining days information.

<9> The image forming apparatus according to <8>, wherein
the number of remaining days is obtained by

Rd=(DL−Cd)/Da,
where Rd represents the number of remaining days,
DL represents an image forming distance per day by the image forming apparatus included in the life information,
Cd represents a current distance that is an image forming distance by the image forming apparatus up to a present time, and
Da represents an average image forming distance per day by the image forming apparatus.

<10> The image forming apparatus according to any one of <1> to <9>, wherein
the control circuitry
   acquires life approaching information related to an approaching end of the life of the fixer based on visiting day number information and the life information, the visiting day number information being related to a number of days taken until a visiting day when a service person of the image forming apparatus actually visits the image forming apparatus after requesting the service person to visit the image forming apparatus, and
   outputs the life approaching information.

<11> The image forming apparatus according to <10>, wherein the control circuitry replaces initial life approaching information related to an approaching end of the life of the fixer with the life approaching information acquired based on the operation state of the fixer and the visiting day number information.

<12> The image forming apparatus according to any one of <1> to <11>, further including:
a storage configured to store the operation state of the fixer, wherein
the control circuitry acquires information related to the operation state of the fixer by referring to the storage.

<13> The image forming apparatus according to any one of <1> to <12>, wherein the fixer includes:
a holding member configured to hold the fixing member at both ends;
a sliding member configured to slide with an inner periphery of the fixing member;
a pressurizing member configured to be disposed against an outer peripheral surface of the fixing member;
a nip forming member arranged inside the fixing member and configured to be disposed against the pressurizing member via the sliding member and the fixing member to form a nip portion;
a supporting member configured to support the nip forming member;
a heat source arranged inside the fixing member and configured to heat the fixing member; and
a reflecting member configured to reflect radiant heat from the heat source, wherein
the fixing member is flexible and endless.

<14> The image forming apparatus according to <13>, wherein a gap is formed between the fixing member and the holding member.

<15> The image forming apparatus according to <14>, wherein
a lubricant is applied to the sliding member, and
the lubricant flows out of the fixer through the gap.

<16> An image forming method executed by an image forming apparatus, the image forming method including:
forming, by an image former, an image on a recording medium;
fixing, by a fixer including a fixing member that is rotatable, the image onto the recording medium, by causing the recording medium on which the image is formed by the image former to be disposed against the fixing member;
driving, by a driver, the fixing member; and
acquiring, by control circuitry, life information related to a life of the fixer based on either a driving current or a torque of the driver and an operation state of the fixer, and outputting the acquired life information.

<17> A program that causes an image forming apparatus to execute a process, the process including:
forming, by an image former, an image on a recording medium;
fixing, by a fixer including a fixing member that is rotatable, the image onto the recording medium, by causing the recording medium on which the image is formed by the image former to be disposed against the fixing member;
driving, by a driver, the fixing member; and
acquiring, by control circuitry, life information related to a life of the fixer based on either a driving current or a torque of the driver and an operation state of the fixer, and outputting the acquired life information.

According to one embodiment of the present invention, it is possible to provide an image forming apparatus with high accuracy in acquiring the life information of the fixing unit.

The image forming apparatus, the image forming method, and the recording medium are not limited to the specific embodiments described in the detailed description, and variations and modifications may be made without departing from the spirit and scope of the present invention.

What is claimed is:

1. An image forming apparatus comprising:
a processor; and
a memory that includes instructions, which when executed, cause the processor to execute:
forming, by an image former, an image on a recording medium;
fixing, by a fixer including a fixing member that is rotatable, the image onto the recording medium, by causing the recording medium on which the image is formed by the image former to be disposed against the fixing member;
driving, by a driver, the fixing member; and
acquiring, by control circuitry, life information related to a life of the fixer based on either a driving current or a torque of the driver and an operation state of the fixer, and outputting the acquired life information.

2. The image forming apparatus according to claim 1, wherein the operation state of the fixer includes at least one of an average number of image forming pages per job by the image forming apparatus, an average number of image forming pages per month by the image forming apparatus, an average number of image forming pages per day by the image forming apparatus, or an average image forming distance per day by the image forming apparatus.

3. The image forming apparatus according to claim 1, wherein the acquiring includes acquiring the life information based on the operation state of the fixer when the driving current of the driver becomes a predetermined current threshold value or more.

4. The image forming apparatus according to claim 3, wherein the instructions, which when executed, cause the processor to execute:
changing, by the control circuitry, the predetermined current threshold value based on the operation state and a number of days until a visiting day of a service person.

5. The image forming apparatus according to claim 1, wherein the instructions, which when executed, cause the processor to execute:
replacing, by the control circuitry, initial life information related to an initial life of the fixer with the life information acquired based on the operation state of the fixer.

6. The image forming apparatus according to claim 1, wherein the acquiring includes acquiring the life information based on the driving current of the driver and temperature information related to a temperature of the fixing member based on the operation state of the fixer.

7. The image forming apparatus according to claim 1, wherein the acquiring includes acquiring the life information further based on visiting day number information related to a number of days taken until a visiting day when a service person of the image forming apparatus actually visits the image forming apparatus, after requesting the service person to visit the image forming apparatus.

8. The image forming apparatus according to claim 1, wherein the acquiring includes acquiring remaining days information related to a number of remaining days until the fixer reaches an end of the life based on the driving current of the driver and the operation state of the fixer, and the acquired remaining days information is output.

9. The image forming apparatus according to claim 8, wherein
the number of remaining days is obtained by
Rd=(DL−Cd)/Da,
where Rd represents the number of remaining days,
DL represents an image forming distance by the image forming apparatus included in the life information,
Cd represents a current distance that is an image forming distance by the image forming apparatus up to a present time, and
Da represents an average image forming distance per day by the image forming apparatus.

10. The image forming apparatus according to claim 1, wherein
the acquiring includes
acquiring life approaching information related to an approaching end of the life of the fixer based on visiting day number information and the life information, the visiting day number information being related to a number of days taken until a visiting day when a service person of the image forming apparatus actually visits the image forming apparatus after requesting the service person to visit the image forming apparatus, and
outputting the life approaching information.

11. The image forming apparatus according to claim 10, wherein the instructions, which when executed, cause the processor to execute:
replacing, by the control circuitry, initial life approaching information related to an approaching end of the life of the fixer with the life approaching information acquired based on the operation state of the fixer and the visiting day number information.

12. The image forming apparatus according to claim 1, wherein the instructions, which when executed, cause the processor to execute:
storing, in a storage, the operation state of the fixer, wherein
the acquiring includes acquiring information related to the operation state of the fixer by referring to the storage.

13. The image forming apparatus according to claim 1, wherein the fixer includes:
a holding member configured to hold the fixing member at both ends;
a sliding member configured to slide with an inner periphery of the fixing member;
a pressurizing member configured to be disposed against an outer peripheral surface of the fixing member;
a nip forming member arranged inside the fixing member and configured to be disposed against the pressurizing member via the sliding member and the fixing member to form a nip portion;
a supporting member configured to support the nip forming member;
a heat source arranged inside the fixing member and configured to heat the fixing member; and
a reflecting member configured to reflect radiant heat from the heat source, wherein
the fixing member is flexible and endless.

14. The image forming apparatus according to claim 13, wherein a gap is formed between the fixing member and the holding member.

15. The image forming apparatus according to claim 14, wherein
a lubricant is applied to the sliding member, and
the lubricant flows out of the fixer through the gap.

16. An image forming method executed by an image forming apparatus, the image forming method comprising:
forming, by an image former, an image on a recording medium;
fixing, by a fixer including a fixing member that is rotatable, the image onto the recording medium, by causing the recording medium on which the image is formed by the image former to be disposed against the fixing member;
driving, by a driver, the fixing member; and
acquiring, by control circuitry, life information related to a life of the fixer based on either a driving current or a torque of the driver and an operation state of the fixer, and outputting the acquired life information.

17. A non-transitory computer-readable recording medium storing a program that causes a computer to execute a process performed in an image forming apparatus, the process comprising:
forming, by an image former, an image on a recording medium;
fixing, by a fixer including a fixing member that is rotatable, the image onto the recording medium, by causing the recording medium on which the image is formed by the image former to be disposed against the fixing member;
driving, by a driver, the fixing member; and
acquiring, by control circuitry, life information related to a life of the fixer based on either a driving current or a torque of the driver and an operation state of the fixer, and outputting the acquired life information.
